(19) United States
(12) Patent Application Publication
(10) Pub. No.: US 2023/0164597 A1
(43) Pub. Date: May 25, 2023

(54) DETECTING SLEEPING CELLS OF RADIO UNIT IN WIRELESS COMMUNICATION SYSTEM

(71) Applicant: Sterlite Technologies Limited, Gurugram (IN)

(72) Inventors: Nitin Kumar, Gurugram (IN); Manish Jamwal, Gurugram (IN); Rishi Nandwana, Gurugram (IN); Gurpreet Singh, Gurugram (IN)

(73) Assignee: Sterlite Technologies Limited, Gurugram (IN)

(21) Appl. No.: 17/705,354

(22) Filed: Mar. 27, 2022

(30) Foreign Application Priority Data
Nov. 21, 2021 (IN) 202111053487

(51) Int. Cl. H04W 24/04; H04W 24/08

(52) U.S. Cl. CPC H04W 24/04; H04W 24/08

(57) ABSTRACT

The present disclosure provides detection of sleeping cells in a Low-PHY (lower physical) layer of an Open Radio Unit (O-RU) (200), where the O-RU detects such sleeping cells. The O-RU demodulates received digital In-phase and Quadrature-phase (IQ) samples transmitted from an Open Distributed Unit (O-DU) (100) via a user plane from a fronthaul interface (302). The received digital IQ samples include a control data and a user data and the control data corresponds to a base data. Further, the O-RU stores the demodulated digital IQ samples in a Yang model with IQ sample receiving time details, monitors the digital IQ samples for a defined time period and compare the digital IQ samples with the base data and captures a change in the base data as a count of the base data is the same for the defined time period or not.

### TECHNICAL FIELD

The present disclosure relates to a wireless communication system, and more specifically, relates to a method and a system for detecting sleeping cells in a radio unit (RU) in the wireless communication system.

### BACKGROUND

A sleeping cell is an unlocked cell that radiates but has no alarms and is unable to set up traffic (for packet or voice calls), thereby resulting in bad user experience and revenue leakage. Typically, a user associated with a user equipment is unable to latch on such a cell. This problem i.e., sleeping cell problem is one of the common and most critical issues for cellular deployments, consisting of outage of a cellular station, which, conversely, works properly from the point of view of a monitoring system. This problem is often not detectable by an operator, and it could lead to severe degradation in the service provision. The sleeping cell issue has been commonly managed by a centralized analysis of network performance indicators.

Additionally, multiple methods to detect sleeping cell issue such as 0 Random Access Channel (RACH) attempts, 0 radio resource control (RRC) connection request, 0-E-UTRAN Radio Access Bearer (E-RAB) requests, no Packet Data Convergence Protocol (PDCP) traffic, etc. exist, however, all above methods work on a Baseband Unit (BBU) and are not limited to a radio unit (RU) in a traditional RAN (Radio Access Network) architecture solution.

Some of the prior art references are given below:

US20210051751A1 disclose systems and methods for recovering from sleeping cell failures in wireless wide area network (WWAN) radio communication systems. The disclosed technology includes an Internet of Things (IoT) module (e.g., an IoT sensor and controller device) that monitors a cell for entry into a sleeping cell state, and upon detection of entry into a sleeping cell state, reset the cellular radio cell. Resetting the cell reboots the internal processors to recover from the locked condition caused by the sleeping cell state. Powering on the IoT device initiates a connection request to the cellular radio cell to be monitored, and if the connection is successful, the device downloads (or redownloads) configuration parameters for use in monitoring the radio cell. The IoT device then attempts to connect to a remote server or host using the monitored cell (e.g., by sending a ping request to the remote server/host). If the IoT device manages to reach the remote server/host, it waits for a delay that is programmed/configured from the downloaded configuration parameters and attempts to reach the remote server/host again. This repeated reachability test confirms that the monitored cell is alive. If the IoT device is unable to reach the remote server/host after several retries programmed/configured from the downloaded settings, it concludes that the cell is in a sleeping cell state (particularly when other performance metrics are okay, and no alarms have been triggered to otherwise indicate a problem). The IoT device then initiates a cell reset to recover from the sleeping cell error.

WO2020260752A1 discloses sleeping cells in communication networks in which an automated communication network monitoring and control system that is configured to detect sleeping cells in the communication network and optionally provide automatic recovery of the situation. The automated solution can be employed in a network operation control, NOC, functionality of a communication network. The automated solution may monitor and control a whole communication network or parts of it.

US20090034452A1 discloses a wireless transmits/receive unit configured to receive system-level information, including discontinuous reception (DRX) information, cell selection information, and RACH information. The system-level information is received as defined parameters assigned to system information blocks or signaled through dedicated RRC signaling.

WO2017028393A1 discloses a method for generating a detection strategy of the sleeping cell, wherein the detection strategy includes maintaining duration, detecting parameters, and parameter thresholds. Further, the method includes determining the cell to be detected and querying each detection parameter in the hold duration of each cell to be detected before the detection and comparing each detection parameter with a corresponding parameter threshold, when the comparison result of a cell satisfies the sleeping cell When the condition is met, it is determined that the cell is a sleeping cell.

US10103821B2 discloses a method performed in a cellular communication network for establishing that the first cell of said network is unable to receive uplink radio signals. The method comprises determining that no indicative radio message has been received from any radio device during a predetermined time. The method also comprises, in view of said determining, requesting a second cell, neighboring the first cell, to instruct each of at least one radio device, connected to said second cell and able to detect said first cell, to transmit a radio signal. The method also comprises obtaining information about how to receive the radio signal. The method also comprises determining that the radio signal was not successfully received by the first cell in accordance with the obtained information.

While the prior arts cover various approaches for detecting sleeping cells, however, these approaches are unsuitable for the radio units that will characterize 5G deployments. In light of the above-stated discussion, there is a need to overcome the above stated disadvantages.

### OBJECT OF THE DISCLOSURE

A principal object of the present disclosure is to provide a method and a system for detecting sleeping cells in a radio unit (RU) to improve user experience and network capacity.

Another object of the present disclosure is to detect the sleeping cells in a downlink (DL)

Another object of the present disclosure is to compute transmitted IQ (in phase and quadrature phase) samples and time taken for transmission of the IQ samples.

Yet another object of the present disclosure is to trigger an alarm based on detection of the sleeping state of a cell in the RU.

### SUMMARY

The present disclosure provides detection of sleeping cells in a Low-PHY (lower physical) layer of an Open Radio Unit (O-RU), where the O-RU detects such sleeping cells. The O-RU demodulates received digital In-phase and Quadrature-phase (IQ) samples transmitted from an Open Distributed Unit (O-DU) via a user plane from a fronthaul interface. The received digital IQ samples include a control data and a user data and the control data corresponds to a base data. The control data is the count of bits for a downlink and the data calculated for at least one of channels: Synchronization Signal Block (SSB), Master Information Block (MIB) data, System Information Block-1 (SIB-1), physical downlink control channel (PDCCH), and a Paging Control Channel (PCCH).

The O-RU calculates the demodulated IQ samples received from the O-DU via the user plane, where the IQ samples are captured from the fronthaul interface while transmitting the IQ samples from the O-DU to the O-RU for a single periodicity.

Further, the O-RU stores the demodulated digital IQ samples in a Yang model with IQ sample receiving time details, monitors the digital IQ samples for a defined time period and compare the digital IQ samples with the base data and captures a change in the base data as a count of the base data is the same for the defined time period or not. The O-RU is considered in a sleeping state if the base data for the defined time period is the same. Herein, the defined time period is tunable by a user and if no user data is being received at any O-RU and only the base data is being transmitted, then the O-RU is considered in the sleep state. Accordingly, the O-RU generates and notifies an alarm to an Element Management System (EMS) when the sleeping state of the O-RU is detected and the O-RU restarts automatically after finding the O-RU in the sleeping state. The sleeping state of the O-RU is detected in at least one of a downlink (DL) direction.

The O-RU calculates the stored IQ samples through the Yang model, wherein the IQ samples are a processing result of converted digital signals at the O-RU. Additionally, the O-RU compares the number of modulated IQ samples transmitted to the O-RU from the O-DU with the number of IQ samples present in the O-RU for the defined time period, wherein the IQ samples are captured from the fronthaul interface.

According to the present disclosure, a cell data acquired by the EMS is used to query detection parameters of a to-be-detected O-RU in a hold duration before the detection, an alarm information of the O-RU, and a configuration information of the O-RU.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 illustrates a reference architecture for an O-DU (Open Distributed Unit) and an O-RU (Open Radio Unit) in a wireless communication system.

FIG. 2 illustrates a split option 7-2x in connection with the FIG. 1.

FIG. 3 shows various hardware components of the O-RU for detecting sleeping cells in a Low-PHY (lower physical) layer of the O-RU.

FIG. 4 illustrates a flow chart of a method for detecting sleeping cells in the Low-PHY layer of the O-RU.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Standard networking terms and abbreviation: RAN: a RAN (Radio Access Network) may stand for radio access network. The RAN may be a part of a telecommunications system which may connect individual devices to other parts of a network through radio connections. The RAN may provide a connection of user equipment (UE) such as mobile phone or computer with the core network of the telecommunication systems. The RAN may be an essential part of access layer in the telecommunication systems which utilize base stations (such as e node B, g node B) for establishing radio connections.

Active bearer: An active bearer corresponds to tunnel connections between the UE and a packet data network gateway to provide a service.

O-RAN: O-RAN (Open Radio Access Network) is an evolved version of prior radio access networks, makes the prior radio access networks more open and smarter than previous generations. The O-RAN provides real-time analytics that drive embedded machine learning systems and artificial intelligence back-end modules to empower network intelligence. Further, the O-RAN includes virtualized network elements with open and standardized interfaces. The open interfaces are essential to enable smaller vendors and operators to quickly introduce their own services or enables operators to customize the network to suit their own unique needs. Open interfaces also enable multivendor deployments, enabling a more competitive and vibrant supplier ecosystem. Similarly, open-source software and hardware reference designs enable faster, more democratic and permission-less innovation. Further, the O-RAN introduces a self-driving network by utilizing new learning-based technologies to automate operational network functions. These learning-based technologies make the O-RAN intelligent. Embedded intelligence, applied at both component and network levels, enables dynamic local radio resource allocation and optimizes network wide efficiency. In combination with O-RAN’s open interfaces, AI-optimized closed-loop automation is a new era for network operations.

QoS Class identifier (QCI): QCI level corresponds to a QoS value required by an active bearer in the UE to provide the service.

Near real time RAN Intelligent Controller (Near-RT RIC): Near-RT RIC is a logical function that enables near-real-time control and optimization of O-RAN elements and resources via fine-grained data collection and actions over E2 interface.

Non-Real Time Radio Intelligent Controller (Non-RT-RIC): Non-RT-RIC is a logical function that enables non-real-time control and optimization of RAN elements and resources, AI/ML workflow including model training and updates, and policy-based guidance of applications/features in near-RT RIC. It is a part of the Service Management & Orchestration Framework and communicates to the near-RT RIC using the A1 interface. Non-RT control functionality (> 1s) and near-Real Time (near-RT) control functions (< 1s) are decoupled in the RIC. Non-RT functions include service and policy management, RAN analytics and model-training for some of the near-RT RIC functionality, and non-RT RIC optimization.

O-CU is O-RAN Central Unit, which is a logical node hosting RRC (Radio Resource Control), SDAP (Service Data Adaptation Protocol) and PDCP (Packet Data Convergence Protocol).

O-CU-CP is O-RAN Central Unit - Control Plane, which is a logical node hosting the RRC and the control plane part of the PDCP protocol.

The O-CU-UP is O-RAN Central Unit - User Plane, which is a logical node hosting the user plane part of the PDCP protocol and the SDAP protocol.

O-DU is O-RAN Distributed Unit, which is a logical node hosting RLC/MAC/High-PHY layers based on a lower layer functional split.

O-RU is O-RAN Radio Unit, which is a logical node hosting Low-PHY layer and RF processing based on a lower layer functional split. This is similar to 3GPP’s “TRP” or “RRH” but more specific in including the Low-PHY layer (FFT/iFFT, PRACH extraction).

O1 interface is an interface between management entities in a Service Management and Orchestration (SMO) Framework and O-RAN managed elements, for operation and management, by which FCAPS management, Software management, File management shall be achieved.

xAPP is an independent software plug-in to the Near-RT RIC platform to provide functional extensibility to the RAN by third parties.” The near-RT RIC controller can be provided different functionalities by using programmable modules as xAPPs, from different operators and vendors.

gNB: New Radio (NR) Base stations which have capability to interface with 5G Core named as NG-CN over NG-C/U (NG2/NG3) interface as well as 4G Core known as Evolved Packet Core (EPC) over S 1-C/U interface.

LTE eNB: An LTE eNB is evolved eNodeB that can support connectivity to EPC as well as NG-CN.

Non-standalone NR: It is a 5G Network deployment configuration, where a gNB needs an LTE eNodeB as an anchor for control plane connectivity to 4G EPC or LTE eNB as anchor for control plane connectivity to NG-CN.

Standalone NR: It is a 5G Network deployment configuration where gNB does not need any assistance for connectivity to core Network, it can connect by its own to NG-CN over NG2 and NG3 interfaces.

Non-standalone E-UTRA: It is a 5G Network deployment configuration where the LTE eNB requires a gNB as anchor for control plane connectivity to NG-CN.

Standalone E-UTRA: It is a typical 4G network deployment where a 4G LTE eNB connects to EPC.

Xn Interface: It is a logical interface which interconnects the New RAN nodes i.e., it interconnects gNB to gNB and LTE eNB to gNB and vice versa.

Reference signal received power (RSRP): RSRP may be defined as the linear average over the power contributions (in [W]) of the resource elements that carry cell-specific reference signals within the considered measurement frequency bandwidth.” RSRP may be the power of the LTE Reference Signals spread over the full bandwidth and narrowband.

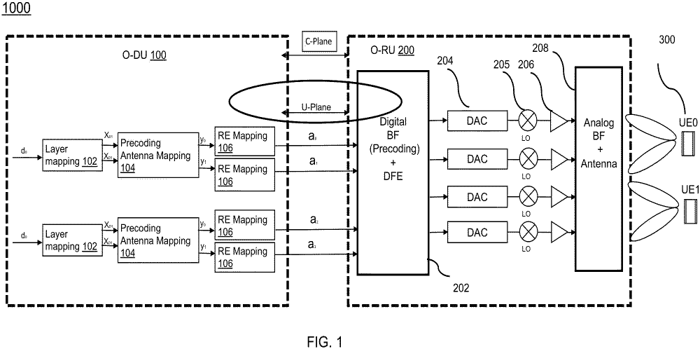

FIG. 1 illustrates a reference architecture for an O-DU (Open Distributed Unit) (100) and an O-RU (Open Radio Unit) (200) in a wireless communication system (1000).

The O-DU (100) is a logical node that provides RLC (Radio link control), MAC (Medium Access Control), and higher physical layer (high-PHY) functions, and the O-RU (200) (interchangeably used as RU (200)) connected to the O-DU (100) is a logical node that provides low-PHY functions and radio frequency (RF) processing. For example, a plurality of O-RUs (200) may be connected to one O-DU (100), and a plurality of O-DUs (100) may be connected to one O-CU-UP (not shown).

The O-RU (200) and the O-DU (100) may be connected through a connector i.e., fronthaul (FH) connection. In this case, the O-RU (200) and the O-DU (100) each may perform a function of a physical layer. In a physical layer for downlink (DL) in a 4G or 5G communication system, channel coding and scrambling for a received data by receiving downlink data from a media access control (MAC) layer (not shown in FIG) and layer mapping of the modulation symbol is performed (at 102) after modulation is performed on the scrambled data. The modulation symbol mapped to each layer is mapped to each antenna port (at 104) and is mapped to a corresponding resource element (RE) (at 106), resulting in an IQ sampling sequence. Digital beamforming (which can be mixed with precoding) is performed on the modulation symbol (at 202), and inverse fast Fourier transform (FFT) (IFFT) is performed to transform the same into a time domain signal. Thereafter, a cyclic prefix (CP) is added, and the modulation symbol is carried on a carrier frequency in at least one of a transmitter and receiver (TRX) radio module and transmitted to a plurality of user equipments (UE’s) (300) through an antenna (208).

The TRX radio module (or TRX module) may include, for example, Digital-to-Analog Converter (DAC) (204), a local-oscillator (LO) phase shifter (205) and a power amplifier (PA) (206).

Generally, a fronthaul (FH) U-plane consists of IQ (in phase and quadrature phase) samples. This includes a Control Plane Data (i.e., control data) and a User Plane Data (user data) (CP+UP). The control data is used to calculate transmitting channel bits and also called as base data. The Control Plane (CP) functional elements handle mostly signalling procedures (e.g., network attachment procedures, management of User-data Plane paths, and even delivery of some lightweight services as SMS). Further, the User-data Plane (UP) functional elements handles mostly packets related to user’s application data like pdf, doc, music files, web browsing, etc.

The control data and the user data form digital IQ samples. The digital IQ samples represent or include a portion of wireless spectrum. In an example, the digital IQ samples can represent a single radio access network carrier (for example, Universal Mobile Telecommunications System (UMTS) or long-term evolution (LTE)) onto which voice or data information has been modulated using a UMTS air interface or an LTE air interface.

Further, the digital IQ samples from an analog wireless signal received at a radio frequency (RF) by down-converting a received signal to an intermediate frequency (IF) or to a baseband, digitizing the down-converted signal to generate real digital samples and digitally down-converting the real digital samples to produce digital IQ samples. These digital IQ samples can also be attenuated, and/or, filtered, and/or, amplified, and/or re-sampled, and/or decimated to a lower sample rate. Each stream of digital IQ samples represents a portion of wireless radio frequency spectrum output by one or more base stations.

A user plane protocol stacked between an eNodeB (Evolved Node B) (not shown), and a UE (300) consists of the following sub-layers: PDCP (Packet Data Convergence Protocol), RLC (radio Link Control), and Medium Access Control (MAC). The UE (300) may be, for example, but not limited to a cellular phone, a smart phone, a Personal Digital Assistant (PDA), a wireless modem, a tablet computer, a laptop computer, a Universal Serial Bus (USB) dongle, an Internet of Things (IoT), a virtual reality device, an immersive system, or the like.

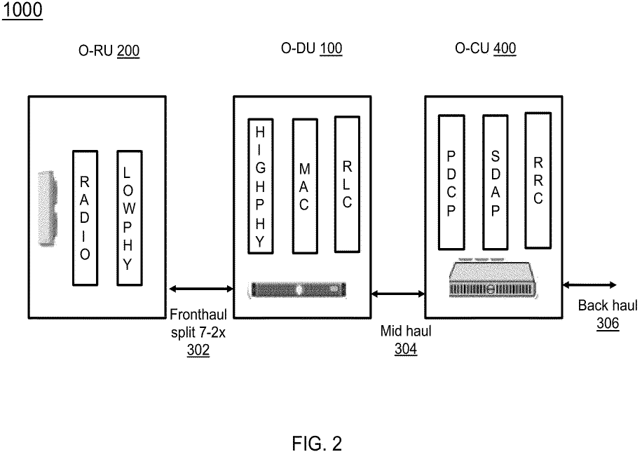

On the user plane, packets in the core network (EPC) are encapsulated in a specific EPC protocol and tunnelled between a primary gateway (P-GW) and the eNodeB. Different tunnelling protocols are used depending on the interface. GPRS Tunnelling Protocol (GTP) is used on the S1 interface between the eNodeB and secondary gateway (S-GW) and on the S5/S8 interface between the S-GW and the P-GW. The packets received by a layer are called Service Data Unit (SDU) while the packet output of a layer is referred to by Protocol Data Unit (PDU) and IP packets at user plane flow from top to bottom layers. Further, the additional details of the O-DU (100) and the O-RU (200) is explained in the FIG. 2.

FIG. 2 illustrates a split option 7-2x in connection with FIG. 1. An O-RAN Fronthaul Spilt with respect to ORAN Alliance is referred as a Lower Layer Split (LLS) having a goal to increase the flexibility and competition on the telecom market. The lower layer split refers to the split between the Open Radio Unit (O-RU) (200) and the Open Distributed Unit (O-DU) (100). The O-RAN fronthaul interface (302) can be transported on an Enhanced Common Public Radio Interface (eCPRI). The eCPRI specification is designed to support 5G fronthaul requirements and offers several advantages e.g., the eCPRI enables the efficient use of packet-based transport technologies and allows RAN payloads to be carried over Ethernet. The higher layers of the O-RU interface are implemented on top of eCPRI, with several different LLS Options (1 to 8) to split the functionality between the O-RU (200) and the O-DU (100).

Further, this functional splitting between the O-DU (100) and the O-RU (200) divides the function of PHY Layer (Layer 1) named as a High PHY residing in the O-DU (100) and a Low PHY (lower physical layer) residing in the O-RU (200).

In a downlink (DL) bits processing or data flow, a user bit sequence received from the higher layer i.e., MAC layer undergoes encoding and scrambling, modulation and layer mapping, and precoding and Resource Element (RE) mapping resulting in the IQ sampling sequence of an OFDM (Orthogonal Frequency Division Multiplexing) signal in the frequency domain. This sequence is then performed Inverse fast Fourier transform (IFFT) processing to convert an OFDM signal in the time domain, and finally converted to an analog signal as described in FIG. 1 as well. In this flow, beam forming is performed before IFFT in the case of digital beam forming (BF) and after analog signal conversion in the case of analog BF.

In a downlink (DL) bits processing or data flow, the OFDM signal in the time domain received at the O-RU (200) and converted to a digital signal fed to FFT processing to get the IQ sample of the OFDM signal in the frequency domain. Then, after RE demapping, the process flow continues with equalizing processing, Inverse Discrete Fourier Transform (IDFT) processing, and channel estimation, and after demodulation, descrambling, and decoding, the process sends a user bit sequence to a MAC layer using various elements (e.g., digital BF (precoding)+DFE (202), the Digital-to-Analog Converter (DAC) (204), the local-oscillator (LO) phase shifter (205), the power amplifier (PA) (206) and an Analog BF and Antenna (208)).

Referring back to the O-DU (100), the O-DU (100) is a commercial off-the-shelf edge server that can function as baseband processing unit to handle the high PHY layer, the MAC layer and the RLC layer with network function virtualization (NFV) or containers. The O-DU (100) connects to the O-RU (200) in the fronthaul interface (302). Further, the O-DU (100) connects to an O-CU (Open-Central Unit) (400) through a midhaul interface (304). Also, the O-CU (400) is provided with the backhaul interface (306).

The O-RU (200) may be configured to demodulate the received digital IQ samples transmitted from the O-DU (100) by the user plane from the fronthaul interface (302). The received digital IQ samples include the control data and the user data, and wherein the control data is referred as a base data. The control data is the count of bits for a downlink. When no UE (300) is served by any particular cell, it is only some common channel and signal (i.e., may be referred as base data or limited system information such as for example, SSB (Synchronization Signal Block) periodicity, MIB (Master Information Block) data, SIB-1 (System Information Block #1), PDCCH (Physical Downlink Control Channel) and PCCH (Paging Channel) data that needs to be transmitted in DL data frame. Thereafter, for a given configuration of SSB periodicity/MIB data/SIB-1/PDCCH/PCCH data, transmitted data (IQ samples) are computed.

The O-RU (200) may be configured to store the demodulated digital IQ samples data in a Yang model at the O-RU (200) with IQ sample receiving time details. Typically, the Yang model is the data modelling language used to model configuration, state data, and administrative actions manipulated by a NETCONF protocol. The O-RU (200) may monitor digital IQ samples for a defined time period and compare the digital IQ samples with the base data. Additionally, the O-RU (200) may be configured to capture a change in the base data as a count of the base data is the same for the defined time period or not. The defined time period is tunable by a user. The O-RU (200) is considered as in a sleeping state if the base data for the defined time period is the same. Alternatively, if no user data is being received at any RU, only base data is being transmitted, then the O-RU (200) is considered in the sleep state. Further, after finding the O-RU (200) in the sleeping state, the O-RU (200) may restart automatically.

Below is an example depiction for the data size calculation for PBCH (Physical Broadcast Channel) configuration:
FR1; upto 8 Beam
Total bits in MIB= 23 (indicated in table 1)
Bit for BCCH type= 1 BCCH-BCH is made of one choice parameter out of two elements (MIB or messageClassExtension)
Total MIB bits = 24
Additional timing payload= 8(4+1+3)
4 = LSB of SFN
1 = Half Frame bit
3 = SS Block time index for FR2 OR 1 extra bit for CRB grid offset (Kssb), remaining 2 are reserved
   Note: - Remaining 3 bits of SS Block are achieved by changing the DMRS sequence
CRC bits= 24
Total= 56 bits
Polar Coding (Coding rate= 11/100 = 0.11
   ➔ Total Bits = 512
Rate Matching= 864 bits
QPSK modulation= 432 symbols
RS in PBCH= 144
Remaining RE in PBCH = 576-144=432
PBCH Total size= 240+240+48+48=576 RE

TABLE 1

| Parameter Name | Values | Number of Bits |
|---|---|---|
| systemFrameNumber | bit string | 6 |
| subCarrierSpacingCommon | scs15or60, scs30or120 | 1 |
| ssbSubCarrierOffset | 0 to 15 | 4 |
| dmrsTypeAposition | pos2, pos3 | 1 |
| pdcchConfigSIB 1 | controlresset (0 to 15), searchspaceZero (0 to 15) | 8 |
| cellBarred | barred, notBarred | 1 |
| intraFreqReselection | allowed, notAllowed | 1 |
| spare | bit string | 1 |
| Total Bits | | 23 |

In the similar way, the IQ sample size may be calculated for other common information transmitted in DL- SIB-1, PCCH, RS, PDCCH.

Herein, total IQ samples are captured from the fronthaul interface, and the base data (BaseData) is stored in the O-RU (200) only in the Yang models, where the BaseData is the size of downlink IQ samples within a periodicity. The O-RU (200) may be configured to calculate the demodulated IQ samples received at the O-RU (200) by the user plane. The IQ samples are captured from the fronthaul interface (302) while transmitting the IQ samples from the O-DU (100) to the O-RU (200) for a single periodicity. Further, the O-RU (200) may be configured to calculate the stored IQ samples in the O-RU (200) through the Yang model wherein the IQ samples are the processing result of converted digital signals at the O-RU (200).

The O-RU (200) may trigger a cell sleeping state when total count of IQ samples = BaseData*T1.

Once sleeping state is triggered, an alarm may be generated and notified to an EMS (Element Management System). Additionally, an automatic O-RU restart may be triggered once ‘X’ time cell sleeping state has been triggered.

That is, the O-RU (200) may be configured to generate and notify the alarm to a centralized network management system (i.e., Element Management System (EMS)) when the O-RU sleeping state is detected. The data (or cell data) acquired by the EMS is used to query detection parameters of a to-be-detected RU in a hold duration before the detection, an alarm information of the O-RU (200), and a configuration information of the O-RU (200).

Further, the O-RU (200) may be configured to compare the number of modulated IQ samples transmitted to the O-RU from the O-DU with the number of IQ samples present in the O-RU (200) for the defined time period.

Unlike conventional methods and systems, the proposed O-RU (200) may be used to effectively monitor sleeping cells in the Low-PHY layer of the O-RU (200), so as to improve user experience and network capacity.

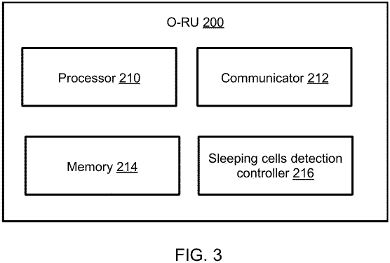

FIG. 3 shows various hardware components of the O-RU (200) for detecting sleeping cells in the low-PHY layer of the O-RU (200) in the wireless communication system (1000). The O-RU (200) may comprise a processor (210), a communicator (212), a memory (214), and a sleeping cells detection controller (216). The processor (210) is configured to execute instructions stored in the memory (214) and to perform various processes of the present disclosure. The communicator (212) is configured for communicating internally between internal hardware components and with external devices via one or more networks.

The sleeping cells detection controller (216) may be configured to demodulate the received digital IQ samples transmitted from the O-DU (100) by the user plane from the fronthaul interface (302). The received digital IQ samples may include the control data and the user data, and the control data is referred as the base data.

The control data is the count of bits for the downlink. When no UE (300) is served by any particular cell, it is only some common channel and signal (i.e., may be referred as base data or limited system information such as for example, SSB (Synchronization Signal Block) periodicity, MIB (Master Information Block) data, SIB-1 (System Information Block #1), PDCCH (Physical Downlink Control Channel) and PCCH (Paging Channel) data that needs to be transmitted in DL data frame. Thereafter, for a given configuration of SSB periodicity/MIB data/SIB-1/PDCCH/PCCH data, transmitted data (IQ samples) are computed.

Additionally, the sleeping cells detection controller (216) may be configured to store the demodulated digital IQ samples data in the Yang model at the O-RU (200) with IQ sample receiving time details. Further, the sleeping cells detection controller (216) may be configured to monitor digital IQ samples for the defined time period and compare the digital IQ samples with the base data. Furthermore, the sleeping cells detection controller (216) may be configured to capture the change in the base data as a count of the base data is the same for the defined time period or not. The O-RU (200) is considered as in a sleeping state if the base data for the defined time period is the same. Alternatively, if no user data is being received at any RU and only the base data is being transmitted, then the O-RU (200) is considered in the sleep state. After finding the O-RU (200) in the sleeping state, the O-RU (200) will restart automatically.

The sleeping cells detection controller (216) may be configured to generate and notify the alarm to the centralized network management system (i.e., Element Management System (EMS)) when the RU sleeping state is detected. Further, the sleeping cells detection controller (216) may be configured to calculate the demodulated IQ samples received at the O-RU (200) by the user plane, wherein the IQ samples are captured from the fronthaul interface (302) while transmitting the IQ samples from the O-DU (100) to the O-RU (200) for a single periodicity.

Further, the sleeping cells detection controller (216) may be configured to calculate the stored IQ samples in the O-RU (200) through the Yang model, wherein the IQ samples are the processing result of converted digital signals at the O-RU (200). The sleeping cells detection controller (216) may be configured to compare the number of modulated IQ samples transmitted to the O-RU (200) from the O-DU (100) with the number of IQ samples present in the O-RU (200) for the defined time period, wherein the IQ samples are captured from the fronthaul interface (302).

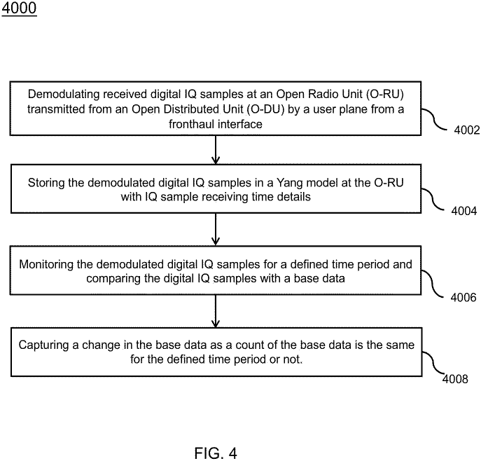

FIG. 4 illustrates a flow chart (4000) of a method for detecting sleeping cells in the low-PHY layer of the O-RU (200) in the wireless communication system (1000). The flow chart (4000) may be read in conjunction with FIG. 1 through FIG. 3.

At step (4002), the method demodulates the received digital IQ samples at the O-RU (200) transmitted from the O-DU (100) by the user plane from the fronthaul interface (302). The received digital IQ samples include the control data and user data, and the control data is referred as the base data. At step (4004), the method includes storing the demodulated digital IQ samples in the Yang model at the O-RU (200) with IQ sample receiving time details. At step (4006), the method includes monitoring the demodulated digital IQ samples for the defined time period and comparing the demodulated digital IQ samples with the base data. At step (4008), the method includes capturing a change in the base data as a count of the base data is the same for the defined time period or not.

Unlike conventional methods and systems, the method can be used to effectively monitor sleeping cells in the Low-PHY layer of the O-RU (200), so as to improve user experience and network capacity.

It may be noted that in order to explain the method steps of the flowchart (4000), references will be made to the elements explained in FIG. 1 to FIG. 3. It may also be noted that the flowchart (4000) is explained to have above stated process steps; however, those skilled in the art would appreciate that the flowchart (4000) may have more/less number of process steps which may enable all the above stated implementations of the present disclosure.

The various actions, acts, blocks, steps, or the like in the flow chart may be performed in the order presented, in a different order or simultaneously. Further, in some implementations, some of the actions, acts, blocks, steps, or the like may be omitted, added, modified, skipped, or the like without departing from the scope of the invention.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. A method of detecting sleeping cells in a Low-PHY (lower physical) layer of an Open Radio Unit (O-RU) (200) in a wireless communication system (1000), comprising:
demodulating received digital In-phase and Quadrature-phase (IQ) samples at the O-RU (200) transmitted from an Open Distributed Unit (O-DU) (100) via a user plane from a fronthaul interface (302), wherein the received digital IQ samples include a control data and a user data and wherein the control data corresponds to a base data;
storing the demodulated digital IQ samples in a Yang model at the O-RU (200) with IQ sample receiving time details;
monitoring the digital IQ samples by the O-RU (200) for a defined time period and comparing the digital IQ samples with the base data; and
capturing a change in the base data by the O-RU (200) as a count of the base data is the same for the defined time period or not.

2. The method as claimed in claim 1, wherein the O-RU (200) is considered in a sleeping state if the base data for the defined time period is the same.

3. The method as claimed in claim 1, wherein the digital IQ samples include the control data and the user data, wherein the control data is the count of bits for a downlink and the data calculated for at least one of channels: Synchronization Signal Block (SSB), Master Information Block (MIB) data, System Information Block-1 (SIB-1), physical downlink control channel (PDCCH), and a Paging Control Channel (PCCH).

4. The method as claimed in claim 1, wherein the method further comprising:
generating and notifying an alarm by the O-RU (200) to an Element Management System (EMS) when the sleeping state of the O-RU (200) is detected.

5. The method as claimed in claim 1, wherein the method further comprising:
calculating the demodulated IQ samples received at the O-RU (200) from the O-DU (100) via the user plane, wherein the IQ samples captured from the fronthaul interface (302) while transmitting the IQ samples from the O-DU (100) to the O-RU (200) for a single periodicity.

6. The method as claimed in claim 1, wherein the method further comprising:
calculating the stored IQ samples in the O-RU (200) through the Yang model, wherein the IQ samples are a processing result of converted digital signals at the O-RU (200).

7. The method as claimed in claim 1, wherein the method further comprising:
comparing the number of modulated IQ samples transmitted to the O-RU (200) from the O-DU (100) with the number of IQ samples present in the O-RU (200) for the defined time period, wherein the IQ samples captured from the fronthaul interface (302).

8. The method as claimed in claim 1, wherein the defined time period is tunable by a user and if no user data is being received at any O-RU and only the base data is being transmitted, then the O-RU (200) is considered in the sleep state.

9. The method as claimed in claim 1, wherein the method further comprising:
restarting the O-RU (200) automatically after finding the O-RU (200) in the sleeping state.

10. The method as claimed in claim 2, wherein a cell data acquired by the EMS is used to query detection parameters of a to-be-detected O-RU (200) in a hold duration before the detection, an alarm information of the O-RU (200), and a configuration information of the O-RU (200).

11. The method as claimed in claim 1, wherein the sleep state of the O-RU (200) is detected in the downlink (DL) direction.

12. An Open Radio Unit (O-RU) (200) for detecting sleeping cells in a Low-PHY (lower physical) layer of the O-RU (200) in a wireless communication system (1000), the O-RU (200) is configured to:
demodulate received digital In-phase and Quadrature-phase (IQ) samples transmitted from an Open Distributed Unit (O-DU) (100) via a user plane from a fronthaul interface (302), wherein the received digital IQ samples include a control data and a user data and wherein the control data corresponds to a base data;
store the demodulated digital IQ samples in a Yang model with IQ sample receiving time details;
monitor the digital IQ samples for a defined time period and compare the digital IQ samples with the base data; and
capture a change in the base data as a count of the base data is the same for the defined time period or not.

13. The O-RU (200) as claimed in claim 12, wherein the O-RU (200) is considered in a sleeping state if the base data for the defined time period is the same.

14. The O-RU (200) as claimed in claim 12, wherein the digital IQ samples include the control data and the user data, wherein the control data is the count of bits for a downlink and the data calculated for at least one of channels: Synchronization Signal Block (SSB), Master Information Block (MIB) data, System Information Block-1 (SIB-1), physical downlink control channel (PDCCH), and a Paging Control Channel (PCCH).

15. The O-RU (200) as claimed in claim 12, wherein the O-RU (200) generates and notifies an alarm to an Element Management System (EMS) when the sleeping state of the O-RU (200) is detected.

16. The O-RU (200) as claimed in claim 12, wherein the O-RU (200) calculates the demodulated IQ samples received from the O-DU (100) via the user plane, wherein the IQ samples captured from the fronthaul interface (302) while transmitting the IQ samples from the O-DU (100) to the O-RU (200) for a single periodicity.

17. The O-RU (200) as claimed in claim 12, wherein the O-RU (200) calculates the stored IQ samples through the Yang model, wherein the IQ samples are a processing result of converted digital signals at the O-RU (200).

18. The O-RU (200) as claimed in claim 12, wherein the O-RU (200) compares the number of modulated IQ samples transmitted to the O-RU (200) from the O-DU (100) with the number of IQ samples present in the O-RU (200) for the defined time period, wherein the IQ samples captured from the fronthaul interface (302).

19. The O-RU (200) as claimed in claim 12, wherein the defined time period is tunable by a user and if no user data is being received at any O-RU and only the base data is being transmitted, then the O-RU (200) is considered in the sleep state.

20. The O-RU (200) as claimed in claim 12, wherein the O-RU (200) restarts automatically after finding the O-RU (200) in the sleeping state.

21. The O-RU (200) as claimed in claim 13, wherein a cell data acquired by the EMS is used to query detection parameters of a to-be-detected O-RU (200) in a hold duration before the detection, an alarm information of the O-RU (200), and a configuration information of the O-RU (200).

22. The O-RU (200) as claimed in claim 12, wherein the sleep state of the O-RU (200) is detected in the downlink (DL) direction.
